(19) United States
(12) Patent Application Publication
(10) Pub. No.: US 2021/0059111 A1
(43) Pub. Date: Mar. 4, 2021

(54) DETERMINING APPARATUS FOR DETERMINING A DATUM DURING THE HARVESTING OF FRUIT, CORRESPONDING TREATMENT APPARATUS AND HARVESTING VEHICLE

(71) Applicant: EXEL Industries, Epernay (FR)

(72) Inventors: Johannes BUCH, Paris (FR); Michael GALLMEIER, Ergoldsbach (DE); Steffen SCHWICH, Paris (FR); Jan SCHATTENBERG, Paris (FR); Carsten CRUSE, Paris (FR)

(21) Appl. No.: 16/990,658

(22) Filed: Aug. 11, 2020

(30) Foreign Application Priority Data
Aug. 27, 2019 (DE) 102019122905.7

(51) Int. Cl. A01D 33/00; H04W 4/44; G06N 20/00; G06N 5/04; A01D 25/00; A01D 33/10

(52) U.S. Cl. CPC A01D 33/00; H04W 4/44; G06N 20/00; A01D 2033/005; A01D 25/00; A01D 33/10; G06N 5/04

(57) ABSTRACT

This determining apparatus (62) for determining a datum during the harvesting of fruit (4), for example, sugar beets, comprises a fruit flow apparatus (50) for the treatment of a flow (52) of harvested fruit, a sensor device (64) for detecting a raw datum of the flow, a determining device (66) connected to the sensor device for determining a datum of the flow based on the raw datum. The datum is a quality datum or a yield datum of the flow. The determining apparatus is designed to output a signal, which corresponds to the quality datum or the yield datum. The quality datum or the yield datum reflects an item of information about a net yield of the harvested fruit.

The invention relates to an apparatus according to the preamble of patent claims 1 and 15, and to a harvesting vehicle according to the preamble of patent claim 18.

A harvesting vehicle for harvesting root crops or sugar beets is known from EP110395, which has a harvesting or uprooting unit on the front side and in which the harvested root crops are conveyed on an upward conveyor or elevator over a transport section, which runs in the vehicle longitudinal direction under the vehicle frame, via which the root crops are then introduced in a hopper provided on the vehicle frame.

The harvesting vehicle comprises an apparatus for detecting the conveyed quantity or the weight of the root crops, which is obtained from the drive data (torque/speed) of the upward conveyor.

However, the detected quantity reflects only the conveyed quantity (i.e., gross quantity) and permits no conclusion about the actually usable quantity of the root crop (net quantity). However, the conveyed quantity also comprises unusable portions, such as leaves, damaged root crops, sections, stones, clods of earth, or the like.

A problem addressed by the invention is to indicate an apparatus, which permits the improvement of the harvesting process with simple and cost-efficient means.

Furthermore, the aim is to improve the detection of the yield or the quality of the harvested root crops.

In order to solve this problem, the invention relates to:
A determining apparatus for determining a datum during the harvesting of fruit, comprising
   a fruit flow apparatus for the treatment of a flow of harvested fruit,
      a sensor device for detecting a raw datum of the flow,
   a determining device connected to the sensor device for determining a datum of the flow based on the raw datum,
characterized in that
the datum is a quality datum or a yield datum of the flow,
the determining apparatus is designed to output a signal which corresponds to the quality datum or the yield datum,
and wherein the quality datum or the yield datum reflects an item of information about a net yield of the harvested fruit.
According to further aspects, the determining apparatus may have one or more of the following features:
   The fruit flow apparatus comprises one or more of:
      an uprooting unit for uprooting the fruit,
      a transport unit for transporting the uprooted fruit,
      a cleaning unit for cleaning the uprooted fruit, and
      a storage unit of the uprooted fruit.
   The fruit flow apparatus comprises the transport unit and the sensor device is arranged such that it can detect the flow of harvested fruit on the transport unit.
   The transport unit is arranged between the cleaning unit and an upward conveyor.
   The quality datum comprises at least one of the following data:
surface injuries to the fruit, cracks in the fruit, fruit sections, soil attachments, impurities, leaf attachments, weed attachments or weeds,
or the yield data comprise a net weight of the usable fruit and a gross weight comprising the net weight and the weight of the unusable portion of the flow.
   The sensor device contains a sensor unit, which comprises one or more of:
      a 2D camera,
      a 3D camera,
      a radar sensor,
      a sensor for detecting the fruit flow weight,
      a radiometric sensor,
      a capacitive sensor, and
      a lidar sensor.
   The determining device comprises a computing unit for determining the quality datum or the yield datum,
      wherein the computing unit is remote from the sensor unit and is connected by communication means to the sensor unit or
      wherein the computing unit is mechanically connected to the sensor unit and with the latter forms a module that can be handled jointly.
   Either wherein the computing unit is an on-board computer of a vehicle,
or wherein the communication means comprise wireless communication means and the computing unit is not mounted on a vehicle and is not mechanically connected to the sensor unit (Cloud computer/Internet).
   The determining device has a unit for providing an additional datum, which is designed to provide one or more of:
additional machine-internal data,
machine external data,
data from other harvesting machines,
weather data,
soil data.
   The determining device is designed to generate an environmental datum from the sensor datum or from the raw datum or from the quality datum or from the yield datum.
   The environmental datum reflects one or more of the soil type, the soil moisture, and the weather conditions.
   The determining apparatus comprises at least one determining aid means, which increases or supports the detecting quality of the sensor apparatus.
   The determining aid means comprises one or more of
      an additional illumination means,
      an at least one crop flow bypass,
      a crop cleaning device,
      a sensor cleaning device,
      a shield against interfering influences.
   The fruit is root crops or sugar beets.
Another aspect of the disclosed object relates to a treatment apparatus for a harvesting machine, comprising a determining apparatus as above, wherein the treatment apparatus furthermore comprises a control unit for controlling the fruit flow apparatus of the determining apparatus in dependence on the quality datum or the yield datum in that the net yield is increased based on the current net yield.
Further aspects of the treatment apparatus may comprise:
   The control unit comprise means for machine learning, which change the parameters of the control of the control unit based on historical data of the control of the fruit flow apparatus by the control unit and the resulting change of the net yield.
   The parameters of the control is changed under given framework conditions in that the net yield is increased.
A harvesting machine or vehicle for harvesting root crops or sugar beets is also disclosed which comprises a determining apparatus or a treatment apparatus as above.

The advantage of the apparatus according to the present invention consists, among other things, in that a continuous detection of the quality or of the harvesting conditions can be carried out during the harvesting.

The individual disclosed features of the invention and the embodiments can in each case be used individually or jointly in the disclosed combination or in any other technically possible sub-combination and are thus to be regarded as disclosed.

Further developments of the invention are the subject matter of the dependent claims.

If in each case a functional feature is disclosed below, then the corresponding method feature is thus also to be regarded explicitly as disclosed therewith.

Each of the features disclosed together is to be regarded as disclosed in any technically possible combination.

The invention is elucidated in detail below by means of the figures in an embodiment.

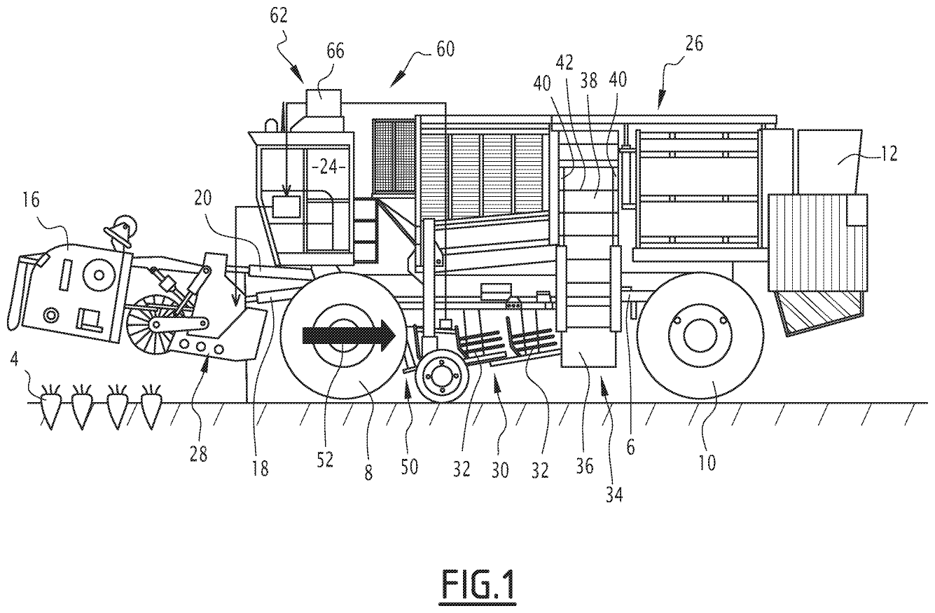

FIG. 1 shows in a side representation a harvesting or uprooting vehicle for uprooting or harvesting root crops, in particular sugar beets;

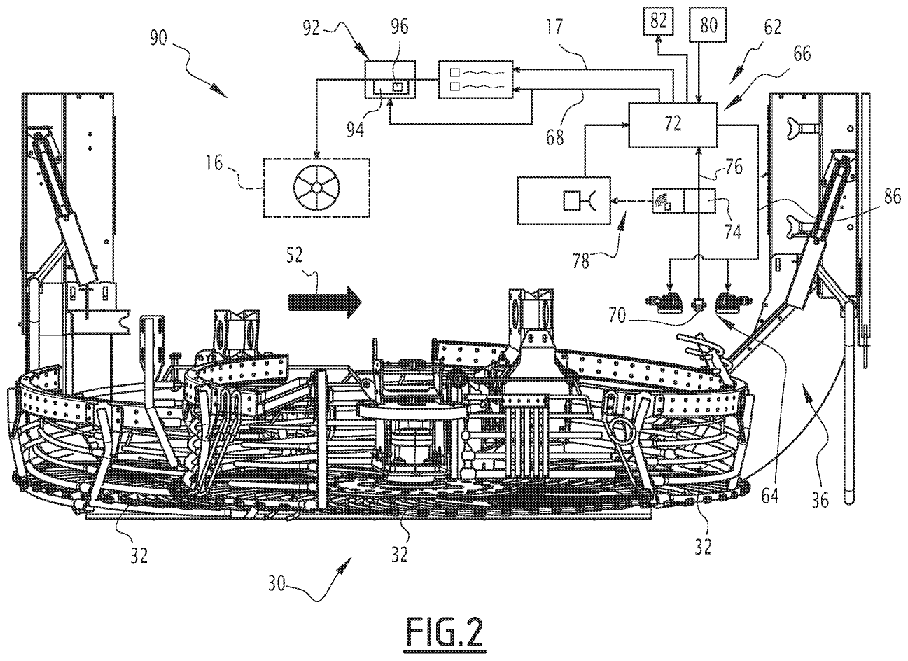

FIG. 2 shows in a side view a transport section of the vehicle of FIG. 1 and a schematic view of different components of the determining apparatus of the invention; and

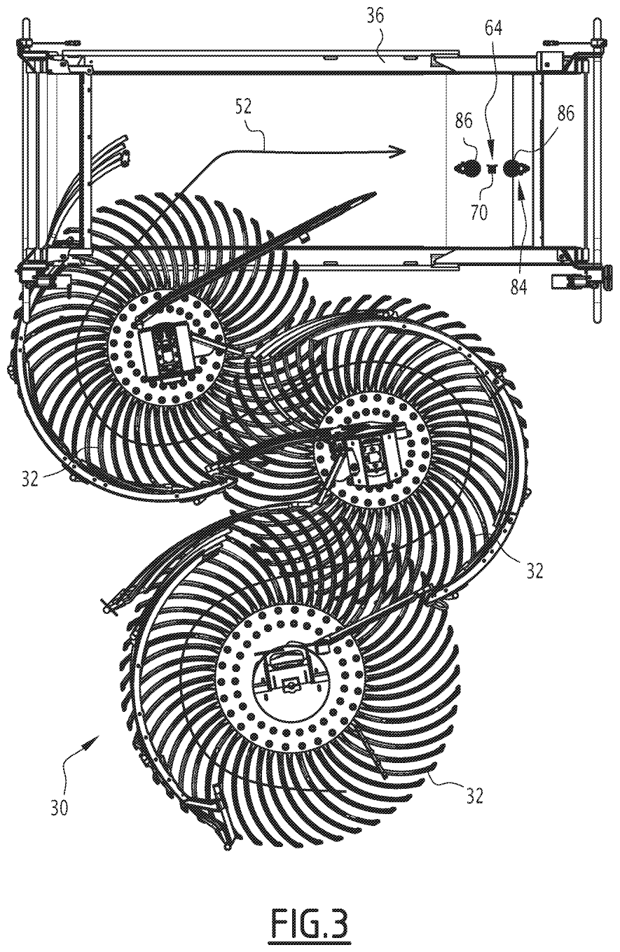

FIG. 3 shows a top view of the transport section of FIG. 2.

The harvesting or uprooting vehicle or machine in the figures generally designated by 2 is used for harvesting or uprooting sugar beets 4 or similar root crops and comprises a frame 6, on which vehicle axles with corresponding wheels 8, 10 are provided. At least the front wheels 8 and the rear wheels 10 are driven by a drive 12 of the vehicle 2.

On the front side of the frame 6 a uprooting unit 16 is provided, specifically raiseable and lowerable by means of actuating elements, which in the embodiment depicted are hydraulic cylinders 18 and 20, so that in the known manner the uprooting unit 16 can be raised and can be lowered for the uprooting or harvesting. On the front side of the frame 6 a driver's cab 24 is provided, which is then followed by a storage unit 26, for example, in the form of an open hopper for receiving the harvested sugar beets 4.

The uprooting of the sugar beets 4 takes place with the uprooting unit 16 at the same time in a plurality of rows. The harvested sugar beets 4 thereby pass from the uprooting unit 16 via a first transport unit 28, and via a subsequent cleaning unit 30, which is formed in the embodiment depicted from several successive and in each case rotationally driven screening stars 32, to a second transport unit 34. The first transport 28 unit comprises transport rollers. The second transport unit 34 comprises a feeding belt 36. The feeding belt 36 conveys the harvested beets to the delivery position of a third transport unit, in the present case an upward conveyor 38.

The upward conveyor 38 comprises at least one endlessly rotating drivable belt 40. Drivers 42, which protrude over the side of the belt 40 and form supports for the sugar beets 4, are provided on the belt at regular intervals

The harvesting or uprooting vehicle 2 comprises a fruit flow apparatus 50, which comprises the uprooting unit 16 for uprooting the fruit, one or several transport units for transporting the uprooted fruit, for example, the transport units 28 and 34, the cleaning unit 30 for cleaning the uprooted fruit, and/or the storage unit 26 of the uprooted fruit.

The fruit flow apparatus 50 is designed to treat a flow 52 of harvested fruit 4.

Depending on the configuration of the harvesting or uprooting vehicle 2, some of the aforementioned units of the fruit flow apparatus 50 can be omitted, can be changed among themselves in their order, can be exchanged or be replaced by other units. The fruit flow apparatus can comprise the uprooting unit 16 for uprooting the fruit, the transport unit 36 for transporting the uprooted fruit, the cleaning unit 30 for cleaning the uprooted fruit, and/or the storage unit 26 of the uprooted fruit in any technically possible combination desired. Individual or a plurality of said units can also, if necessary, be omitted or replaced by other apparatuses.

The harvesting or uprooting vehicle 2 also comprises an on-board computer 60, which is designed to control the individual units of the vehicle. For this purpose, the vehicle 2 comprises the corresponding sensors, input/output means such as screens and keyboards, as well as actuators, which are connected to the on-board computer.

The harvesting or uprooting vehicle 2 furthermore comprises a determining apparatus 62 for determining a datum of the flow of the harvested fruit.

The determining apparatus 62 comprises
a sensor device 64 for detecting a raw datum of the flow 52,
a determining device 66 connected to the sensor device 64 for determining a datum of the flow 52 based on the raw datum.

The datum of the flow to be determined is a quality datum or a yield datum of the flow according to the present invention, wherein the quality datum or the yield datum reflects an item of information about a net yield of the harvested fruit.

The determining apparatus 62 is designed, for example, to output a signal via a signal line 68, which signal corresponds to the quality datum or the yield datum.

The quality datum can comprise at least one or a plurality of the following data of the flow 52 and this in any combination and/or sub-combination desired: Surface injuries to the fruit, cracks in the fruit, fruit sections, soil attachments, impurities, leaf attachments, weed attachments or weeds.

The yield datum of the flow 52 can comprise a net weight of the usable fruit as well as a gross weight comprising the net weight and the weight of the unusable portion of the flow.

The information about the net yield is an item of information, which indicates which usable mass the fruit have at the time of the harvesting. For example, the information about the net yield is an item of information based on the degree of injury to the fruit (quality datum). On the basis of this degree of injury an estimation can be made, as to which portion of the fruit, for example, due to rotting or sugar breakdown due to storage, will no longer be usable until further treatment. Therefore, by means of the information about the net yield a statement about the future useful yield of the harvested fruit can also be made.

The sensor device 64 comprises a sensor unit 70, which has
a 2D camera, or/and
a 3D camera, or/and
a radar sensor, or/and
a sensor for detecting the fruit flow weight, or/and
a radiometric sensor, or/and
a capacitive sensor, or/and
a lidar sensor.

The raw datum is, for example, the image generated by the camera or the signal output by the sensor.

In the present case, the sensor device 64 or the sensor unit 70 comprises a 2D camera, which generates an image or a sequence of images of the flow 52 of harvested fruit, which is conveyed from the uprooting unit 16 to the storage unit 26.

More precisely, the sensor device 64 is advantageously arranged such that it detects the fruit flow on the second transport unit 34 (or the feeding belt 36) between the cleaning device 30 (or the screening stars 32) and the third transport unit (or the upward conveyor 38). Alternatively, the sensor device 64 can also detect, for example, the fruit flow on the screening stars 32 or on the upward conveyor 38.

The determining device 66 comprises a computing unit 72 for determining the quality datum or the yield datum. According to the embodiment depicted, the computing unit 72 is remote from the sensor unit 70 and connected by communications means 74 to the sensor unit. However, both units 70, 74 are arranged on the harvesting and uprooting vehicle 2.

The computing unit 72 can be a separate on-board computer of the vehicle, or a part of the on-board computer 60.

The communication means 74 comprise, for example, wired communication means 76, such as cables or data buses. Alternatively, the communication means 74 comprise wireless communication means 78, such as, for example, Bluetooth, or Wi-Fi communication paths.

Alternatively, and in a manner not depicted the computing unit 72 is mechanically connected to the sensor unit 70 and forms a jointly manageable module with said sensor unit.

Alternatively, the communication means 74 comprise wireless communication means and the computing unit 72 or a part of the computing unit is not attached to the vehicle and is not mechanically connected to the sensor unit 70. In this case, the computing unit 72 is a computer, which is connected to the Internet and the wireless communication means permits the computing unit to receive and to process the signals of the sensor unit 70 in a distributed manner (Cloud computer/Internet).

The determining device 66 can additionally have a unit 80 for providing an additional datum, which is designed to provide additional machine-internal and/or external data, such as, for example, data from other harvesting machines, weather data or soil data.

The computing unit 72 is thereby designed to generate the quality datum or the yield datum from the additional datum and the raw datum of the sensor device 64 or the sensor unit 70. For example, more precise statements about the quality of the fruit flow can be made from the weather data of the area that has just been uprooted, together with the image information of the 2D camera.

In an analogous manner, the determining device can be designed to generate an environmental datum from the sensor datum or from the raw datum or from the quality datum or the yield datum, which reflects, in particular, the soil type, soil moisture, and/or the weather conditions. For this purpose, the determining device 66 can contain a unit 82 for generating the environmental datum.

The determining apparatus 66 furthermore comprises at least one determining aid means 84, which increases or supports the detecting quality of the sensor apparatus. The determining aid means 84 in the present case comprises an additional illumination means 86, which illuminates the image field of the sensor apparatus 70.

Alternatively, or additionally, the determining aid means 84 of one or a plurality of the following elements comprise: At least one crop flow bypass or/and a crop cleaning device or/and a sensor cleaning device or/and a shield against interfering influences.

The crop flow bypass is, for example, a bypass section along which a first part of the flow is guided, so that this part is detected by the sensor apparatus 70 and a second part of the flow is passed by the sensor apparatus and is not detected. Thus, the detecting quality at least of the first part of the flow can be improved. In particular, the computing effort for determining the quality datum or yield datum can thus be kept low and the detection conditions (for example, good contrast) can be improved for the sensors (camera).

The crop cleaning device can, for example, be a spray device or a brush device, which cleans the harvested fruit, before said fruit are detected by the sensor apparatus 70.

The sensor cleaning device can, for example, be a wiping device, which cleans the sensor surface.

The shield can, for example, be a protective sheet, which protects the sensor apparatus against dirt.

Furthermore, the harvesting vehicle or harvesting machine comprises a treatment apparatus 90 for the treatment of the flow 52. The treatment apparatus 90 comprises the determining apparatus 66 as well as a control unit 92 for controlling the fruit flow apparatus of the determining apparatus in dependence on the quality datum or the yield datum in that the net yield is increased based on the current net yield.

For this purpose, the control unit 92 is connected, for example, to the signal line 68, and thus receives the quality datum or the yield datum.

Based on the current quality datum or yield datum, the control unit 92 can thus have an impact on the conveying section, for example, to control the uprooting unit 16 such that the net yield is increased and preferably a maximum possible net yield is obtained. For example, the control unit 92 can change the height setting of the scalper of the uprooting unit or the height setting of the uprooting elements, such that the beets have less or a minimum of injuries. The control unit 92 comprises, for example, a computing unit 94.

Preferably, the control unit comprises means for machine learning 96, which change the parameters of the control of the control unit based on historical data, for example, from the control of the fruit flow apparatus by the control unit 92 and the resulting changes of the net yield. The parameters are in this connection changed in that under given framework conditions, the control is changed by the control unit in that the net yield is increased.

1. A determining apparatus for determining a datum during the harvesting of fruit, comprising
a fruit flow apparatus for the treatment of a flow of harvested fruit,
a sensor device for detecting a raw datum of the flow,
a determining device connected to the sensor device for determining a datum of the flow based on the raw datum,
characterized in that
the datum is a quality datum or a yield datum of the flow,
the determining apparatus is designed to output a signal which corresponds to the quality datum or the yield datum,
and wherein the quality datum or the yield datum reflects an item of information about a net yield of the harvested fruit.

2. The determining apparatus according to claim 1, wherein
the fruit flow apparatus comprises one or more of:
an uprooting unit for uprooting the fruit,
a transport unit for transporting the uprooted fruit,
a cleaning unit for cleaning the uprooted fruit, and
a storage unit of the uprooted fruit.

3. The determining apparatus according to claim 2, wherein
the fruit flow apparatus comprises the transport unit and the sensor device is arranged such that it can detect the flow of harvested fruit on the transport unit.

4. The determining apparatus according to claim 3, wherein the transport unit is arranged between the cleaning unit and an upward conveyor.

5. The determining apparatus according to claim 1, wherein
the quality datum comprises at least one of the following data:
surface injuries to the fruit, cracks in the fruit, fruit sections, soil attachments, impurities, leaf attachments, weed attachments or weeds,
or the yield data comprise a net weight of the usable fruit and a gross weight comprising the net weight and the weight of the unusable portion of the flow.

6. The determining apparatus according to claim 1, wherein
the sensor device contains a sensor unit, which comprises one or more of:
a 2D camera,
a 3D camera,
a radar sensor,
a sensor for detecting the fruit flow weight,
a radiometric sensor,
a capacitive sensor, and
a lidar sensor.

7. The determining apparatus according to claim 6, wherein
the determining device comprises a computing unit for determining the quality datum or the yield datum,
wherein the computing unit is remote from the sensor unit and is connected by communication means to the sensor unit or
wherein the computing unit is mechanically connected to the sensor unit and with the latter forms a module that can be handled jointly.

8. The determining apparatus according to claim 7,
either wherein the computing unit is an on-board computer of a vehicle,
or wherein the communication means comprise wireless communication means and the computing unit is not mounted on a vehicle and is not mechanically connected to the sensor unit (Cloud computer/Internet).

9. The determining apparatus according to claim 1, wherein the determining device has a unit for providing an additional datum, which is designed to provide one or more of:
additional machine-internal data,
machine external data,
data from other harvesting machines,
weather data,
soil data.

10. The determining apparatus according to claim 1, wherein the determining device is designed to generate an environmental datum from the sensor datum or from the raw datum or from the quality datum or from the yield datum.

11. The determining apparatus according to claim 10, wherein the environmental datum reflects one or more of the soil type, the soil moisture, and the weather conditions.

12. The determining apparatus according to claim 1, wherein the determining apparatus comprises at least one determining aid means, which increases or supports the detecting quality of the sensor apparatus.

13. The determining apparatus according to claim 12, wherein the determining aid means comprises one or more of
an additional illumination means,
an at least one crop flow bypass,
a crop cleaning device,
a sensor cleaning device,
a shield against interfering influences.

14. The determining apparatus according to claim 1, wherein the fruit is root crops or sugar beets.

15. A treatment apparatus for a harvesting machine, comprising a determining apparatus according to claim 2,
characterized in that the treatment apparatus furthermore comprises:
a control unit for controlling the fruit flow apparatus of the determining apparatus in dependence on the quality datum or the yield datum in that the net yield is increased based on the current net yield.

16. The treatment apparatus for a harvesting machine according to claim 15, wherein the control unit comprise means for machine learning, which change the parameters of the control of the control unit based on historical data of the control of the fruit flow apparatus by the control unit and the resulting change of the net yield.

17. The treatment apparatus for a harvesting machine according to claim 16, wherein the parameters of the control is changed under given framework conditions in that the net yield is increased.

18. A harvesting vehicle for harvesting root crops or sugar beets, comprising a determining apparatus or a treatment apparatus according to claim 1.
